(19) United States
(12) Patent Application Publication
(10) Pub. No.: US 2020/0317350 A1
(43) Pub. Date: Oct. 8, 2020

(54) CABIN SEGMENT HAVING A VACANT SPACE

(71) Applicant: DIEHL AVIATION LAUPHEIM GMBH, Laupheim (DE)

(72) Inventors: Marc Steinmayer, Biberach An Der Riss (DE); Daniel Siessegger, Achstetten (DE); Patrick Leyendecker, Ulm (DE)

(21) Appl. No.: 16/838,380

(22) Filed: Apr. 2, 2020

(30) Foreign Application Priority Data
Apr. 5, 2019 (DE) 102019002501

(51) Int. Cl. B64D 11/06; B64C 1/10

(52) U.S. Cl. CPC B64D 11/0691; B64C 1/10

(57) ABSTRACT

A cabin segment of a passenger cabin of a passenger aircraft is directly adjacent a cockpit along a longitudinal axis of the aircraft and includes a cockpit bulkhead transverse to the longitudinal axis which separates the passenger cabin from the cockpit. The cockpit bulkhead contains a cockpit door, wall portions of left and right-side fuselage walls having respective cabin doors and an emergency exit region to be kept free which connects the cabin doors. The cabin segment ends level with foremost passenger seats and contains a sub-space left of the cockpit door and a sub-space right of the cockpit door. One of the sub-spaces is a vacant space between the cockpit bulkhead and the foremost passenger seats which extends to the fuselage wall and contains neither a galley nor a lavatory.

### CROSS-REFERENCE TO RELATED APPLICATION

This application claims the priority, under 35 U.S.C. § 119, of German Patent Application DE 10 2019 002 501, filed Apr, 5, 2019; the prior application is herewith incorporated by reference in its entirety.

### BACKGROUND OF THE INVENTION

### Field of the Invention

The invention relates to a cabin segment of a passenger cabin of a passenger aircraft. The cabin segment is disposed directly adjacent the cockpit of the passenger aircraft along a longitudinal axis of the passenger aircraft, counter to an intended flight direction of the passenger aircraft, and from there reaches up to a foremost one or a foremost plurality of the passenger seats.

For example, a passenger aircraft Airbus A320 having the following cabin segment is known from practical use: a passageway to the cockpit which is disposed in the form of a forward entrance region so as to be slightly offset in relation to the center is formed by two monuments on the right and the left of the passageway (when viewed in the flight direction) in the cabin segment. The right monument is the galley monument, and the monument to the left of the cockpit aisle is the lavatory monument including (CAS) cabin attendant seats which are disposed in the cabin at the external wall (thus facing counter to the flight direction and towards the passengers). The passenger seats are disposed to the right and the left of the single and thus central cabin aisle and are separated from the entrance region by two partitions.

### SUMMARY OF THE INVENTION

It is accordingly an object of the invention to provide an improved cabin segment having a vacant space, which overcomes the disadvantages of the heretofore-known cabin segments of this general type.

With the foregoing and other objects in view there is provided, in accordance with the invention, a cabin segment which is a segment of a passenger cabin of a passenger aircraft. The cabin segment is directly adjacent the cockpit of the passenger aircraft along a longitudinal axis of the passenger aircraft, counter to the flight direction of the passenger aircraft. The cabin segment contains a cockpit bulkhead which runs transversely to the longitudinal axis of the aircraft. The cockpit bulkhead separates the passenger cabin from the cockpit. The cockpit bulkhead contains a cockpit door so as to reach the cockpit from the passenger cabin and vice versa. The cabin segment contains a left-side wall portion of a left-side fuselage wall, and a right-side wall portion of a right-side fuselage wall of the aircraft. The left-side wall portion contains a left-side cabin door and the right-side wall portion contains a right-side cabin door. The cabin segment contains an emergency exit region which is to be kept free and connects the cabin doors. The phrase “to be kept free” means that no installations in the aircraft must be present in this emergency exit region. The cabin segment (when viewed in the flight direction) contains at least one foremost passenger seat. The latter, in the case of a single-aisle passenger aircraft, are in particular two or three passenger seats in the form of a respective foremost seat row, or first seat row, respectively. The cabin segment ends so as to be level with the foremost passenger seats. The cabin segment thus reaches from the cockpit, or the cockpit bulkhead, respectively, up to and including the foremost passenger seat, or the plurality of the foremost passenger seats.

A left sub-space of the cabin segment is situated to the left of the cockpit door, or the imaginary continuation of the latter counter to the flight direction (inter alia the cockpit aisle); a right sub-space of the cabin segment is correspondingly situated to the right of the cockpit door. In a first alternative, the left part is a vacant space which in the transverse direction (transverse to the longitudinal axis) of the aircraft extends from the cockpit door, in particular the left periphery of the latter, up to the left fuselage wall, and in the longitudinal direction (the direction along the longitudinal axis) of the aircraft extends from the cockpit bulkhead up to (and including) the foremost (left) passenger seats. In a second alternative, the right sub-space is a vacant space which in the transverse direction of the aircraft extends from the cockpit door, in particular the right periphery of the latter up to the right fuselage wall, and in the longitudinal direction of the aircraft extends from the cockpit bulkhead up to and including the foremost (right) passenger seats.

In each of the alternatives described herein the vacant space contains neither a galley nor a lavatory. This is in particular to be understood in such a way that at least no galley/lavatory which is in each case complete, or a monument of this type, respectively, is contained in the vacant space. However, corresponding individual parts, or (additional) components, respectively, which in principle are indeed to be assigned to a galley/lavatory, or are components of such a galley/lavatory or monument, respectively, but do not represent a correspondingly complete galley/lavatory, may indeed be readily present in the vacant space. The corresponding component may in particular be part of, or a component of or an addition to, respectively, a galley and/or a lavatory, for example an individual beverage preparation unit, an oven, a trolley, an Atlas container, etc. It is irrelevant herein whether the component supplements a galley/lavatory that is present at another location of the aircraft, or is a stand-alone unit. The preferred alternative is to provide the vacant space on the left side of the aircraft since the left cabin door which is typically used for boarding and disembarking passengers of the aircraft is situated there. The vacant space in this instance contains the boarding/disembarking region for passengers. In an optionally merely exemplary manner hereunder, the alternative of a left vacant space is at all times assumed, but the statements can be applied in an analogous manner to a right vacant space.

The locational indications “left,” “right,” “front,” “rear,” “top” and “bottom” refer to the aircraft in the flight direction at a level alignment. The longitudinal axis of the aircraft extends along the intended straight-ahead flight direction of the aircraft.

The cabin door is an aircraft door, or an external door, respectively, which is usually used for typically boarding/disembarking passengers (left) or as an emergency exit (right).

The seat, or the seats, respectively, of the cabin segment is/are in particular part of, or form, respectively, that foremost seat row which, counter to the flight direction, thus “behind,” is the first to be adjacent the vacant space.

The invention is based on the following insight: In the above-mentioned layout, of a cabin segment,

due to the monument (lavatory with CAS) which is present to the left of the cockpit door; and

due to the prescribed spacing of at least 60 inches between the seat reference points of the cabin attendant seats and those of the passenger seats,

the first row of the passenger seats, even when the left partition is omitted, cannot be moved forward sufficiently so as to enable a further seat row of passenger seats to the left of the center aisle in the aircraft.

The invention is based on the concept of achieving a vacant space by omitting, or dispensing with, respectively, the left monument (lavatory with CAS). The first left seat row of passenger seats (particularly when omitting the partition on the left side, see below) can thus be displaced forward so far (specifically in particular from the rear up to the permitted minimum spacing from the emergency exit region) that a total of two more passenger seats can be integrated on this left side of the aircraft.

Furthermore, a vacant space (in particular in front of the cabin attendant seats, should the latter be assembled in the vacant space) is thus created. The vacant space can be used as an operating space for a galley (should such a galley be installed, see below) which is opposite in the transverse direction in terms of the cockpit aisle. This vacant space moreover allows a very open construction of the space of the entrance region, potentially having a positive effect in terms of appealing to passengers when boarding the aircraft. Furthermore, this vacant space can be utilized as a private space for the crew and/or passengers (in particular in in-flight phase) in that the region is separated from the remaining part of the passenger cabin in particular by a curtain. The curtain reaches in particular from the rear end of the galley through the vacant space up to the fuselage wall, or to a CAS monument (see below).

A larger spacing between the first passenger seat row and the cockpit bulkhead (or the cabin attendant seats (CAS), should the latter be disposed in the vacant space, see below) is created by the vacant space, due to which the first seat row can be moved further forward. This relocation of the first seat row (in particular two passengers or in subsequent seat rows three passengers) further to the front overall leads to two additional passenger seats being able to be installed in the aircraft (for example in the Airbus A320 mentioned in an exemplary manner).

In the case in which cabin attendant seats are to be disposed in the vacant space, the cabin attendant seats in contrast to the above-mentioned layout can be relocated to the front, to the location of the original interior of the omitted lavatory. The open vacant space in front of CAS (or behind, in the flight direction, respectively) is thus created or enlarged, respectively.

In one preferred embodiment, no partition is disposed in the vacant space between the cockpit bulkhead and the foremost passenger seats. For that reason, there is no minimum spacing between the passenger seats and the partition that has to be adhered to, and the passenger seats can be moved even further to the front, in particular towards the emergency exit region.

In one preferred embodiment the cabin segment contains a galley and/or a lavatory. The galley or the lavatory, respectively, is disposed in this case outside the vacant space. Therefore, the galley or the lavatory, respectively, are disposed in particular on that side of the cockpit door that is opposite the vacant space, in particular so as to be at least partially or completely in the other, in particular the right, sub-space. Despite the vacant space which is achieved, a galley and/or a lavatory are/is still available in the cabin segment. In the case of the galley, the above-mentioned advantageous combination with the vacant space in particular permits operation from the vacant space in the transverse direction.

In one preferred variant of this embodiment the cabin segment in any case contains the galley. The galley in this case has an L-shape. The latter is created due to the galley extending along the longitudinal axis (I-shape) and a hook-shaped protrusion at that end of the galley that lies counter to the flight direction. The protrusion that forms the L-shape in this case protrudes from the I-shape toward the cockpit door, in a manner transverse to the longitudinal axis. The protrusion in this case protrudes in particular from the sub-space and towards the vacant space. Therefore, the galley can be enlarged without compromising the vacant space, or without the latter being substantially compromised. A galley in the form of an I (along-the-wall structure) in turn has the advantage that the galley does not reach into the cockpit aisle, for example.

In one preferred variant of this embodiment the cabin segment contains the galley and the lavatory. The galley and the lavatory are conjointly embodied as an integrated monument. A monument of this type is also referred to as a “gallatory” (gall[ey-lav]atory). The two functionalities of a galley and a lavatory can thus be implemented in an ideally tight space. The accommodation of the galley and lavatory in the sub-space which is different from the vacant space is thus possible in a particularly effective manner.

In one preferred variant of this embodiment the cabin segment contains the galley and the lavatory. The galley in this case is disposed in the direction transverse to the longitudinal axis, and in the direction towards the cockpit door, so as to be beside the lavatory. The galley by way of the operating side thereof is aligned transversely, in the direction towards the cockpit door. The operation of the galley in terms of the longitudinal axis thus takes place in the transverse direction. The galley in this case has in particular an I-shape (linear extent along the longitudinal axis), or the above-mentioned L-shape. The vacant space, or a cockpit aisle (spatial region in the cabin segment that, proceeding from the cockpit door, extends in the direction of the longitudinal axis, counter to the flight direction), can thus be used for operating the galley.

In one preferred embodiment the cabin segment is a cabin segment of a single-aisle passenger aircraft. A corresponding advantage in terms of space by virtue of creating the vacant space, or additional seats, respectively, have a particularly positive effect in aircraft of this type.

In one preferred embodiment the cabin segment contains at least one cabin attendant seat (CAS), in particular two cabin attendant seats (CAS), which is/are disposed in the vacant space between the cockpit bulkhead and the emergency exit region. Due to the absence of a lavatory and of a galley, there is still sufficient space for a cabin attendant seat to be disposed in the vacant space, without having to dispense with the above-mentioned advantages (additional seats, generous spatial appeal, private space, etc.).

In one preferred variant of this embodiment the cabin segment contains at least one filling element which in the longitudinal direction is disposed between the cockpit bulkhead and the cabin attendant seat. The filling element is in particular a stowage space, a stowage compartment, a dog house, or any other structural element, supply element, functional element, or other element. The filling element can in particular be one of the above-mentioned individual parts, or (additional) components, respectively, which may also be part of, or a component of, or an addition to, respectively, a galley and/or a lavatory, etc. An additional benefit is incorporated in the vacant space due to a corresponding filling element, without having to dispense with the above-mentioned advantages.

Alternatively or additionally, the or a further filling element in the transverse direction can also be disposed so as to be between the cabin attendant seat and the neighboring fuselage wall (or the corresponding portion, respectively). For example, the fuselage wall in the case of a vacant space disposed on the left in the aircraft is the left fuselage wall.

Alternatively or additionally, the or a further filling element can also be disposed above the cabin attendant seat. In this case, this is in particular an overhead stowage compartment.

In one preferred variant of this embodiment the cabin attendant seat, and optionally if and when present, the above-mentioned filling element or filling elements, is/are part of a cabin attendant monument which is disposed in the vacant space. The corresponding components can thus be integrated so as to form a structural unit, specifically the monument.

In one preferred variant of this embodiment the cabin attendant seat is aligned counter to the flight direction. The passenger cabin can thus be monitored from the cabin attendant seat by a cabin attendant in the seated position.

In one preferred variant of this embodiment the cabin attendant seat in the direction of the longitudinal axis is disposed in a specific spacing range from the cockpit bulkhead. The spacing range is chosen in such a way that a prescribed minimum spacing from the foremost passenger seats for all of the permitted installation positions of the latter, in particular the foremost permitted installation position of the passenger seats, is always adhered to. The most critical installation position in this case is that position which leads to a vacant space having the smallest possible extent in the direction of the longitudinal axis, specifically when the foremost passenger seats are disposed directly behind the emergency exit region. “Directly” in this case means by way of the smallest permitted minimum spacing from the emergency exit region. This spacing is a function of various factors, for example the properties of the passenger seat, such as the deformation of the latter at a crash load, etc., and therefore cannot be stated in generally valid numeric values. The spacing range in this case is determined according to the foremost seat position that is theoretically possible, or permissible, respectively, not according to the actual seat position. Any arbitrary seat position for passenger seats can thus be chosen, even if the cabin attendant seat is assembled.

In one preferred variant of this embodiment the foremost passenger seats are actually disposed directly behind the emergency exit region. The above-mentioned conditions for the theoretical seat positions in this instance are in particular also actually fulfilled or met, respectively.

The invention is based on the following insights, observations or considerations, respectively, and also includes the following embodiments. Some of the embodiments herein in a simplifying manner are also referred to as “the invention.” The embodiments herein can also contain parts or combinations of the above-mentioned embodiments, or correspond to the latter, and/or optionally also include embodiments not previously mentioned.

Due to the installation of a combined galley/lavatory monument (operation of the galley: 90° to the flight direction, from the cockpit aisle) to the right (or to the left) in the flight direction of the cockpit aisle, instead of the pure galley monument, the lavatory monument including the cabin attendant seats which are disposed at the external wall in the cabin on the other side of the cockpit aisle (left or right) can be dispensed with. The lavatory monument is replaced by a monument (or individual components) which includes/include the cabin attendant seats so as to be offset towards the front in the flight direction.

According to the invention, two potential additional passenger seats in the aircraft are in particular derived. In particular when the partition (partition between the free spatial region, in particular the entrance region, and the passenger seats) is omitted, the passenger seats can be moved closer to the entrance region. This results in an open spatial construct of the entrance region. This also results in a separated (for example by a curtain) private space for the crew and/or passengers.

According to the invention, a new configuration of the cabin modules in the front entrance region of single-aisle aircraft, especially the A320 family by Airbus, is derived. According to the invention, a vacant space and thus space for more passenger seats is achieved in the aircraft. According to the invention, a vacant space in the entrance region is achieved.

According to the invention, a layout of a single-aisle entrance region is derived, containing a “gallatory” (galley/lavatory monument) and a cabin attendant seat monument.

Other features which are considered as characteristic for the invention are set forth in the appended claims.

Although the invention is illustrated and described herein as embodied in a cabin segment having a vacant space, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a fragmentary, diagrammatic, top-plan view of a passenger aircraft having a cabin segment according to the invention; and

FIG. 2 is a fragmentary, top-plan view of a vacant space of the cabin segment of FIG. 1 in alternative embodiments.

### DETAILED DESCRIPTION OF THE INVENTION

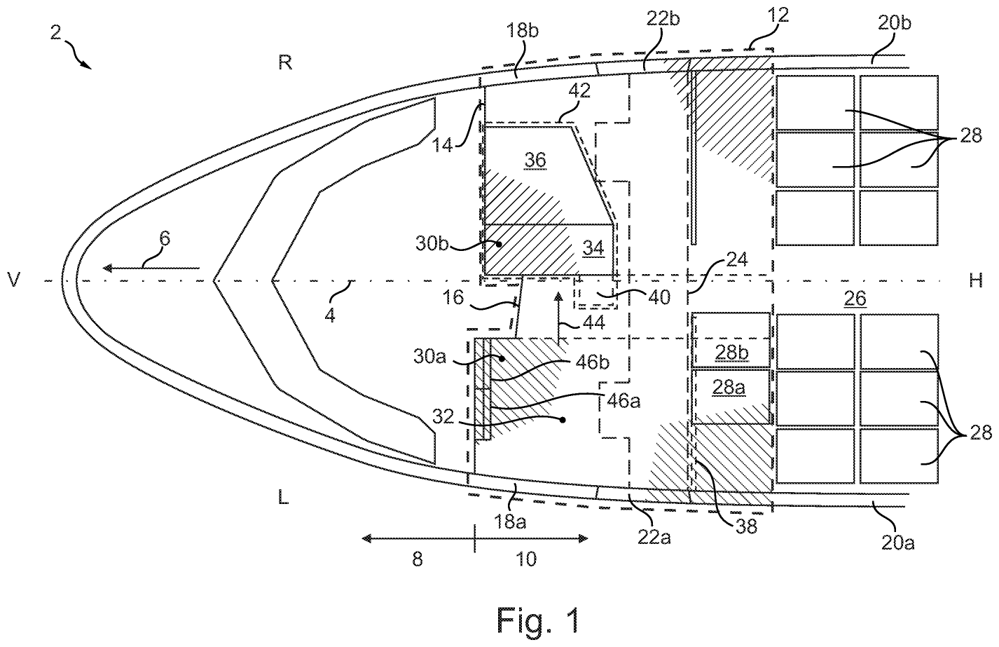

Referring now to the figures of the drawings in detail and first, particularly, to FIG. 1 thereof, there is seen a passenger aircraft 2 which has a longitudinal axis 4 and an intended straight-ahead flight direction 6 in the direction of the longitudinal axis 4. The passenger aircraft 2 has a cockpit 8 at the front (indicated as “V” in the figure) in the flight direction 6. A passenger cabin 10 is adjacent the cockpit 8 towards the rear (indicated as “H” in the figure) along the longitudinal axis 4. The passenger cabin 10 in FIG. 1 has a cabin segment 12 which is bordered by a dashed line and is directly contiguous to the rear of the cockpit 8.

The cabin segment 12 contains a cockpit bulkhead 14 which separates the cockpit 8 from the passenger cabin 10. The cockpit bulkhead 14 runs transversely to the longitudinal axis 4 and contains a cockpit door 16 in the form of a rearwardly offset convexity.

The cabin segment 12 moreover contains a left wall portion 18a (“L” indicates the left side in the figure) of a left fuselage wall 20a having a left cabin door 22a, and a right wall portion 18b (“R” indicates the right side in the figure) of a right fuselage wall 20b having a right cabin door 22b.

An emergency exit region 24 has a single center aisle 26 between two seat rows of respective passenger seats 28 (in this case rows of three seats which are not referred to in more detail) which connects the two cabin doors 22a,b. The passenger aircraft 2 by virtue of having only one center aisle 26 is a single-aisle aircraft.

Moreover, the cabin segment 12, in the present case, includes two foremost passenger seats 28a,b of a left foremost seat row (in this case a row of double seats). The cabin segment 12 ends at the foremost passenger seats 28a,b at the rear in the longitudinal direction.

The cabin segment 12 contains a left sub-space 30a to the left of the cockpit door 16, as well as a right sub-space 30b to the right of the cockpit door 16. Both sub-spaces 30a,b are in each case indicated by a partially hatched area and centrally delimited by a dashed line.

The left sub-space 30a is embodied as a vacant space 32. The vacant space 32 extends in the longitudinal direction from the cockpit bulkhead 14 up to the foremost passenger seats 28a,b (including the latter), and extends in the transverse direction from the cockpit door 16 up to the left fuselage wall 20a, or the left wall portion 18a, respectively.

The vacant space 32 contains neither a galley 34 nor a lavatory 36. A partition 38, which in passenger aircraft of this type is often disposed between the passenger seats 28 and an entrance region close to the left cabin door 22a, is not present in this case and is therefore only indicated by dashed lines.

The galley 34 and the lavatory 36 are disposed outside the vacant space 32, specifically in the right sub-space 30b. The galley 34 in this case is I-shaped, that is to say in a linear manner along the longitudinal axis 4. An alternative embodiment of a galley 34 in an L-shape, which is formed by an additional protrusion 40 of the galley 34 at the rear end of the latter, is illustrated in dashed lines. The protrusion 40 projects towards the vacant space 32, or towards the cockpit door 16, respectively, in the transverse direction (in relation to the longitudinal axis 4).

The galley 34 and the lavatory 36 in this case are embodied as an integrated monument 42, specifically a so-called “gallatory.” The monument 42 having the L-shaped galley 34 is contoured by a dashed line.

The galley 34 in the transverse direction (of the aircraft 2) is disposed beside the lavatory 36 in the direction towards the cockpit door 16. The galley 34 has an operating side 44 (indicated by an arrow) which in the transverse direction points towards the cockpit door 16, or towards the left fuselage wall 20a. Service personnel of the galley 34, when using the latter, can thus be present in the vacant space 32, or behind the cockpit door 16, respectively.

Two cabin attendant seats 46a,b are disposed in the vacant space 32 between the cockpit bulkhead 14 and the emergency exit region 24. The two cabin attendant seats 46a,b are aligned counter to the flight direction 6, or point in that direction, respectively. The cabin attendant seats 46a,b in FIG. 1 are disposed directly on the cockpit bulkhead 14.

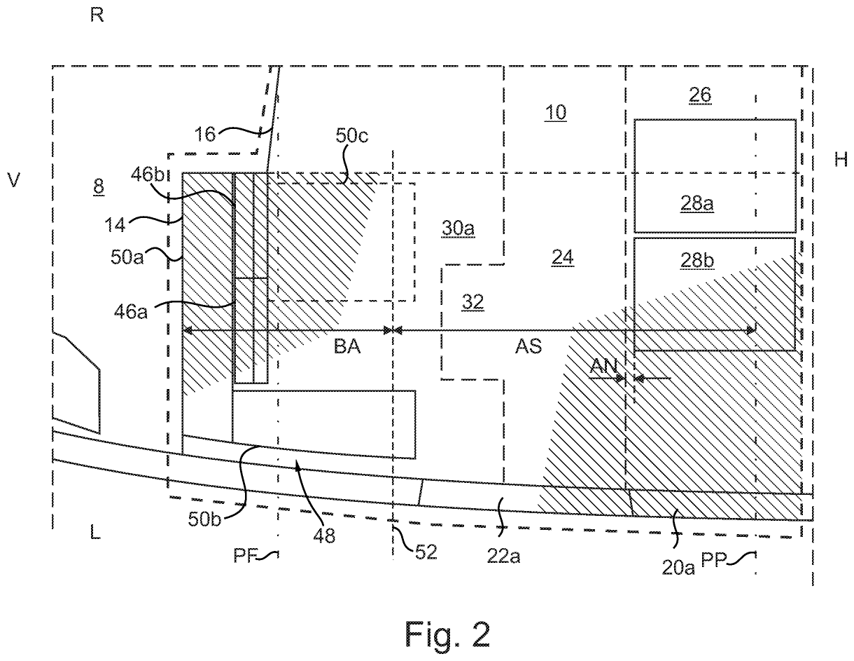

FIG. 2 shows alternative embodiments of the vacant space 32 of FIG. 1. The cabin attendant seats 46a,b in this case are part of a cabin attendant monument 48. Apart from the cabin attendant seats 46a,b, the cabin attendant monument 48 also contains respective filling elements 50a,b, or 50c. The filling element 50a is a stowage compartment (not explained in more detail herein) which is disposed between the cockpit bulkhead 14 and the cabin attendant seats 46a,b in the longitudinal direction. The filling element 50b is disposed between the left cabin attendant seat 46a and the left fuselage wall 20a, and in a manner not explained in more detailed contains a dog house (mini stowage unit) as well as a pull-out table. A further filling element 50c which is optional and therefore indicated in dashed lines is only attached as an overhead stowage compartment (not explained in more detail) above the cabin attendant seats 46a,b.

The foremost passenger seats 28a,b, when viewed in the direction counter to the flight direction 6, are disposed in the cabin segment 12 so as to be directly behind the emergency exit region 24. This means that only a minimum permissible spacing AN, in this case 2.5 inches, from the emergency exit region 24 has been adhered to.

Furthermore, a minimum spacing AS of 60 inches is prescribed in this case between seat reference points PP (the longitudinal position of the latter being indicated by a straight line) of the passenger seats 28a,b and seat reference points PF (indicated by a corresponding straight line) of the cabin attendant seats 46a,b. The seat reference points PF of the cabin attendant seats 46a,b in FIG. 2 are plotted so as to be specific in terms of the actually illustrated installation position of the cabin attendant seats 46a,b.

Therefore, a rearmost permissible assembly position of the cabin attendant seats 46a,b is derived for a given assembly position of the passenger seats 28a,b so that the minimum spacing AS is still just adhered to. The seat reference points PF of the cabin attendant seats 46a,b at the rearmost assembly position of the latter must thus be at most at the transverse line 52, or must be in front of the latter. A spacing range BA for permissible installation positions of the cabin attendant seats 46a,b, or of the seat reference points PF of the latter, which in FIG. 2 is illustrated by a double arrow is thus derived. The spacing range BA therefore extends from the transverse line 52 up to the cockpit bulkhead 14. FIG. 2 shows that this condition is met for the illustrated installation position.

### LIST OF REFERENCE SIGNS

2 Passenger aircraft

4 Longitudinal axis

6 Flight direction

8 Cockpit

10 Passenger cabin

12 Cabin segment

14 Cockpit bulkhead

16 Cockpit door

18a,b Wall portion

20a,b Fuselage wall

22a,b Cabin door

24 Emergency exit region

26 Center aisle

28,28a,b Passenger seat

30a,b Sub-space

32 Vacant space

34 Galley

36 Lavatory

38 Partition

40 Protrusion

42 Monument

44 Operating side

46a,b Cabin attendant seat

48 Cabin attendant monument

50a-c Filling element

52 Transverse line

R right

L left

V front

H rear

AN Minimum spacing (emergency exit region)

AS Minimum spacing (seats)

BA Spacing range

1. In a passenger aircraft having a longitudinal axis, a cockpit, passenger seats including at least one foremost passenger seat, and a passenger cabin having a cabin segment directly adjacent the cockpit along the longitudinal axis and ending level with the at least one foremost passenger seat, the cabin segment comprising:
a cockpit bulkhead running transversely to the longitudinal axis of the aircraft and separating the passenger cabin from the cockpit, said cockpit bulkhead containing a cockpit door;
left-side and right-side fuselage walls each having a respective wall portion with a respective cabin door;
an emergency exit region to be kept free, said emergency exit region interconnecting said cabin doors; and
a left sub-space disposed left of said cockpit door and a right sub-space disposed right of said cockpit door;
one of said sub-spaces being a vacant space extending to said fuselage wall between said cockpit bulkhead and the at least one foremost passenger seat, said vacant space containing neither a galley nor a lavatory.

2. The cabin segment according to claim 1, wherein said vacant space is free of any partition between said cockpit bulkhead and the at least one foremost passenger seat.

3. The cabin segment according to claim 1, which further comprises at least one of a galley or a lavatory disposed outside said vacant space.

4. The cabin segment according to claim 3, wherein said galley extends along the longitudinal axis and has an L-shape at an end of said galley lying counter to a flight direction and a protrusion in a direction towards said cockpit door.

5. The cabin segment according to claim 3, wherein said galley and said lavatory are configured as an integrated monument.

6. The cabin segment according to claim 1, which further comprises a galley and a lavatory disposed outside said vacant space, said galley being disposed alongside said lavatory towards said cockpit door, and said galley having an operating side aligned transversely in a direction towards said cockpit door.

7. The cabin segment according to claim 1, wherein the cabin segment is a cabin segment of a single-aisle passenger aircraft.

8. The cabin segment according to claim 1, which further comprises at least one cabin attendant seat disposed in said vacant space between said cockpit bulkhead and said emergency exit region.

9. The cabin segment according to claim 8, which further comprises at least one filling element disposed in a longitudinal direction between said cockpit bulkhead and said at least one cabin attendant seat in the longitudinal direction.

10. The cabin segment according to claim 8, which further comprises at least one filling element disposed in a transverse direction between said at least one cabin attendant seat and one of said fuselage walls closest to said vacant space.

11. The cabin segment according to claim 8, which further comprises at least one filling element disposed above said at least one cabin attendant seat.

12. The cabin segment according to claim 8, wherein said at least one cabin attendant seat is part of a cabin attendant monument disposed in said vacant space.

13. The cabin segment according to claim 8, which further comprises filling elements, said at least one cabin attendant seat and said filling elements being part of a cabin attendant monument disposed in said vacant space.

14. The cabin segment according to claim 8, wherein said at least one cabin attendant seat is aligned counter to a flight direction.

15. The cabin segment according to claim 8, wherein said at least one cabin attendant seat is disposed in a direction of the longitudinal axis at a spacing range from said cockpit bulkhead ensuring a prescribed minimum spacing from the at least one foremost passenger seat for permitted installation positions of the at least one foremost passenger seat.

16. The cabin segment according to claim 15, wherein the at least one foremost passenger seat is disposed directly behind said emergency exit region.
